(19) United States
(12) Patent Application Publication
(10) Pub. No.: US 2025/0283610 A1
(43) Pub. Date: Sep. 11, 2025

(54) SMART TILE WITH EMBEDDED ELECTRIC HEATING COIL

(71) Applicant: Design & Technical Solutions LLC, Wantagh, NY (US)

(72) Inventor: Sunghoon Jang, Glen Rock, NJ (US)

(21) Appl. No.: 19/204,829

(22) Filed: May 12, 2025

Related U.S. Application Data
(63) Continuation-in-part of application No. 18/599,456, filed on Mar. 8, 2024.

(51) Int. Cl. F24D 13/02; F24D 19/00

(52) U.S. Cl. CPC F24D 13/024; F24D 19/00

(57) ABSTRACT

An heating apparatus is provided. An heating apparatus according to an embodiment of the present disclosure includes a plurality of electric heating tiles arranged on a floor or an interior wall of a building and an at least one side surface cover arranged along a side of at least one of the plurality of electric heating tiles. The first side surface cover of the at least one side surface cover includes an inner space for passing a wire electrically connecting a first electric heating tile and a second electric heating tile of the plurality of electric heating tiles.

### BACKGROUND

### Field

The present disclosure relates to a smart tile having a layer composed of a copper pipe and a copper film or sheet installed inside the tile and a heating wire embedded therein that radiates heat to the upper surface of the tile by a heating cable inserted inside the copper pipe.

### Related Art

In general, plate-shaped interior materials made of tile, wood, metal synthetic resin, and the like are attached to interior walls of buildings to decorate the designated space.

Most of these architectural interior materials have the problem of being heavy, and most of them are used only as simple architectural interior materials that are designed to have only a nice appearance but do not give any functionality.

Meanwhile, heating inside a building is divided into two heating types such as ventilation heating, which heats cold air into warm air using an electric heater and blows the heated air into the room, and radiant heating, which heats a floor or wall and warms the room by radiation from the floor or wall.

In particular, the radiant heating is mainly used today because heating efficiency thereof is relatively good, and a heating method of the radiant heating includes a method of heating the floor or wall by guiding hot water through a pipe under the floor or behind the wall, and a method of heating the floor or wall by embedding an electric wire in the floor or wall.

Here, the hot water heating type is gradually being replaced by the electric wire heating type because there is a risk of water leaking when the pipe rots or is damaged.

However, even in the case of the electric wire heating type, a series of complex construction steps are required as follows. That is, before constructing the floor or wall, the electric wire is first laid on the floor or wall, then cement is poured, and after the cement has hardened and dried, decorative or other surface tiles should be further placed on the upper surface of the cement and fixed thereto. Accordingly, the electric wire heating type disadvantages of requiring a lot of labor, high construction costs, and generating a lot of electromagnetic waves that are harmful to the human body.

To compensate for these shortcomings, floor heating using planar heating elements or linear heating elements, generate less electromagnetic waves and can easily transfer heat, is being used.

In particular, in the construction of floor heating using a planar heating element, an insulating material is laid on the floor to be heated and then applied.

However, since the planar heating element has weak strength, the planar heating element is easily damaged by external impact. Moreover, the planar heating element is weak against moisture, fire may occur due to electric leakage, and when the planar heating element is partially damaged, repair is difficult.

Meanwhile, Korean Patent Publication No. 10-2015-0099894 describes a heating block having a structure in which an upper surface of a square block base where a cover fitting groove and a heating wire fitting groove are formed is covered with a heat-conducting solution or heat-conducting paste, a heating wire is inserted into the heating wire fitting groove, and the cover fitting groove is covered with a cover.

However, in the case of the prior art, since a heating wire and a heat-conducting solution (or heat-conducting paste) are used as a heating medium, it is difficult to secure a sufficient connection area between them, which causes problems such as poor connection and spark generation. Therefore, there are problems in terms of safety as well as decreased functionality.

In addition, in order to insert the heating wire into the square block base, there is a disadvantage in terms of manufacturability and workability that the heating wire should be installed after machining a heating wire fitting groove on the upper surface of the square block base.

Therefore, in order to solve the above problems, there is a need for research on electric heating tiles that are easy to construct and repair, and can be used safely from accidents such as fire.

### SUMMARY

An object of an aspect of the present disclosure is to provide a heating apparatus including a plurality of electric heating tiles arranged on a floor or an interior wall of a building and at least one side surface cover arranged along a side of at least one of the plurality of electric heating tiles.

In addition, an object of an aspect of the present disclosure is to provide a heating apparatus capable of easily connecting electric heating tiles by passing a wire through an inner space of the at least one side surface cover.

An object of an aspect of the present disclosure is to provide a heating apparatus capable of flexibly routing wires through two or more side surface covers.

An object of an aspect of the present disclosure is to provide a heating apparatus capable of containing a power supply unit or other equipment in the inner space of the at least one side surface cover.

An object of an aspect of the present disclosure is to provide a heating apparatus capable of flexibly routing wires between the plurality of electric heating tiles.

An object of one aspect of the present disclosure is to provide an electric heating tile capable of more easily releasing heat generated by a heating cable through an upper surface of the tile by providing a copper pipe, which is made of copper, into which a heating cable such as an electric heating wire is inserted, and a copper film or sheet formed above the copper pipe inside the tile.

In addition, an object of one aspect of the present disclosure is to provide an electric heating tile capable of easily installing and maintaining the tile through coupling by a magnet by providing at least one magnetic member on one side surface.

In addition, an object of one aspect of the present disclosure is to provide an electric heating tile capable of measuring a temperature of a copper pipe and safely controlling a heating state of an electric heating tile by including a control module electrically connected to the electric heating tile.

The problems that the present disclosure aims to solve are not limited to the problems mentioned above, and other problems that the present disclosure aims to solve that are not mentioned here will be clearly understood by those skilled in the art in the technical field to which the present disclosure belongs from the description below.

According to an aspect of the present disclosure, there is provided an heating apparatus including a plurality of electric heating tiles arranged on a floor or an interior wall of a building; and at least one side surface cover arranged along a side of at least one of the plurality of electric heating tiles, in which a first side surface cover of the at least one side surface cover includes an inner space for passing a wire electrically connecting a first electric heating tile and a second electric heating tile of the plurality of electric heating tiles.

The first side surface cover may include a first side facing a side of the first electric heating tile and a side of the second electric heating tile. The first side of the first side surface cover may include a hole or opening for inserting a wire between the first side surface cover and the first electric heating tile and a hole or opening for inserting a wire between the the first side surface cover and the second electric heating tile.

The first side surface cover may include a second side facing a side of a second side surface cover of the at least one side surface cover.

The second side surface of the first side surface cover may include a hole or opening for inserting a wire between the first side surface cover and the second side surface cover.

A second side surface cover of the at least one side surface cover may include an inner space for containing a power supply unit configured to supply power to a wire that runs through at least one electric heating tile of the plurality of electric heating tiles.

The plurality of electric heating tiles may be arranged in a two-dimensional grid. The at least one side surface cover may include: a first plurality of side surface covers arranged along a first outer edge of an area where the plurality of electric heating tiles are arranged in the two-dimensional grid, and a second plurality of side surface covers arranged along a second outer edge of the area, the second outer edge being opposite of the first outer edge with respect to the area.

A wire running through a first row of electric heating tiles in the area and a wire running through a second row of the electric heating tiles in the area may be connected through at least one side surface cover of the first plurality of side surface covers, the second row being adjacent to the first row.

A wire running through at least one row of electric heating tiles in the area may be connected between a power supply unit in a side surface cover arranged along the first outer edge and a ground in a side surface cover arranged along the second outer edge.

Two or more wires each of which runs through different row of electric heating tiles may be connected in parallel between a power supply unit in a side surface cover arranged along the first outer edge and a ground in a side surface cover arranged along the second outer edge.

Adjacent electric heating tiles of the plurality of electric heating tiles may be connected magnetically.

According to an aspect of the present disclosure, there is provided an electric heating tile including: a first layer in which a copper pipe is provided; a second layer provided on the first layer and patterned with at least one copper film or sheet; a top cover configured to cover an upper surface of the second layer; and a bottom cover configured to cover a lower surface of the first layer, in which in the top cover and the bottom lower cover, at least one magnetic member is attached to one side surface.

The bottom cover may include a first inlet provided on one side surface, a second inlet provided on the other side surface facing the first inlet, and an insertion member inserted into the first inlet and the second inlet, and the insertion member may be made of an elastic material and provided in a tubular shape with a through hole penetrating the inside, and the copper pipe may be inserted into the through hole.

The electric heating tile may further include a control module configured to control a heating state of the copper pipe, in which the control module may include a temperature sensor configured to measure a temperature of the top cover, a power supply unit configured to supply power to a heating cable inserted into the copper pipe, a communication unit configured to receive a user control signal from a predetermined user terminal, and a temperature control unit configured to control a heating temperature of the copper pipe based on the user control signal received from the communication unit.

The copper pipe of the first layer may be made of the same material as that of the copper film or sheet of the second layer, and the copper pipe and the copper film or sheet may be joined by soldering, and in the bottom cover, a region where the first layer is mounted may be coated with epoxy.

The electric heating tile may further include a side surface cover having the same thickness as a combined thickness of the bottom cover and the top cover, including an empty space formed therein, and having at least one through hole on one side surface.

According to an aspect of the present disclosure, a copper pipe made of copper material and a copper film or sheet into which a heating cable such as an electric heating wire is inserted are provided inside, so that the heat generated by the heating cable is more easily released through the upper surface of the tile.

In addition, by providing at least one magnetic member on one side surface, it is possible to easily install and maintain the tile through coupling by the magnet.

In addition, by including the control module electrically connected to the electric heating tile, it is possible to measure the temperature of the copper pipe and safely control the heating state of an electric heating tile.

### BRIEF DESCRIPTION OF THE DRAWINGS

FIG. 1 is a configuration diagram of an electric heating tile according to one embodiment of the present disclosure.

FIG. 2 is a diagram for describing a first layer of the electric heating tile according to one embodiment of the present disclosure.

FIG. 3 is a diagram for describing a second layer of the electric heating tile according to one embodiment of the present disclosure.

FIG. 4 is a diagram for describing the combination of the first layer and the second layer of the electric heating tile according to one embodiment of the present disclosure.

FIGS. 5 to 7 are drawings to describe a top cover and a bottom cover of the electric heating tile according to one embodiment of the present disclosure.

FIG. 8 is a diagram for describing a control module of the electric heating tile according to one embodiment of the present disclosure.

FIG. 9 is a drawing to describe a side surface cover of the electric heating tile according to one embodiment of the present disclosure.

FIGS. 10 and 11 are diagrams for describing a fault diagnosis unit provided in the control module of the electric heating tile according to one embodiment of the present disclosure.

FIG. 12 is a configuration diagram of a side surface cover according to one embodiment of the present disclosure.

FIG. 13 is a diagram for describing a side surface cover arranged along a side of electric heating tiles according to one embodiment of the present disclosure.

FIG. 14 is a diagram for describing side surface covers arranged along a side of electric heating tiles according to one embodiment of the present disclosure.

FIG. 15 is a diagram for describing positions of through holes in a side surface cover according to one embodiment of the present disclosure.

FIG. 16 is a diagram for describing positions of through holes in a side surface cover according to one embodiment of the present disclosure.

FIG. 17 is a diagram of a heating apparatus according to one embodiment of the present disclosure.

FIG. 18 is a diagram of a heating apparatus according to one embodiment of the present disclosure.

FIG. 19 is a diagram of a heating apparatus according to one embodiment of the present disclosure.

### DESCRIPTION OF EXEMPLARY EMBODIMENTS

Specific details, including the problem to be solved, means of solving the problem, and effect of the invention regarding the present disclosure as described above, are included in the examples and drawings described below. The advantages and features of the present disclosure, and how to achieve them, will become clear by referring to the embodiments described in detail below along with the accompanying drawings.

The scope of rights of the present disclosure is not limited to the examples described below, and may be modified and implemented in various ways by those with ordinary knowledge in the technical field within the scope of the technical gist of the present disclosure.

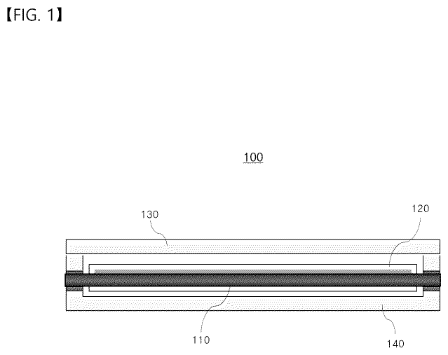

Hereinafter, the title of the invention in the present disclosure will be explained in detail with reference to the attached FIG. 1.

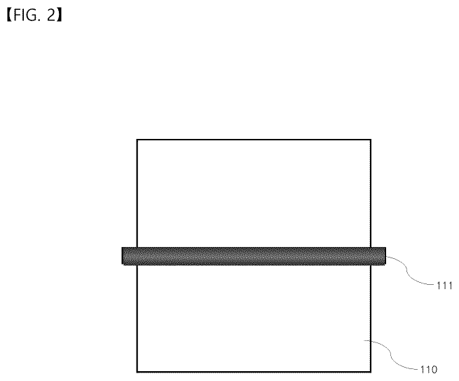

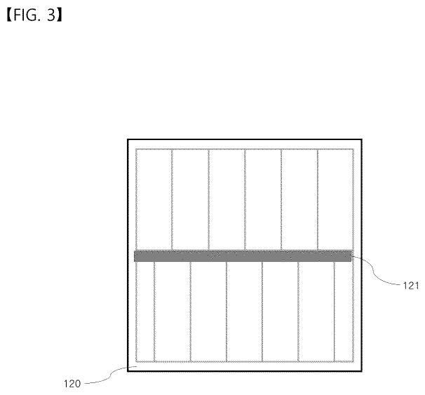

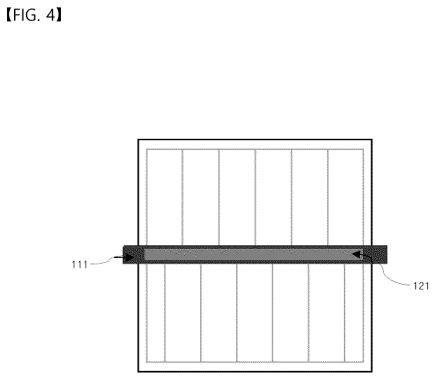

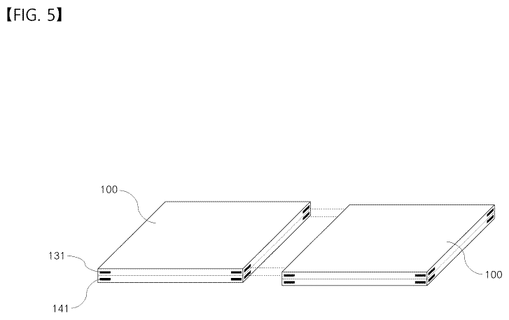

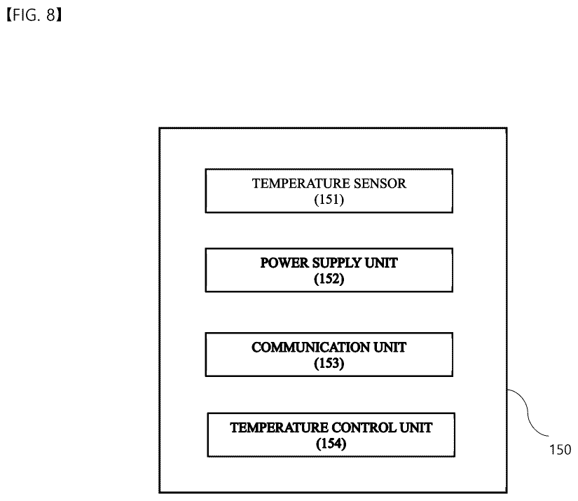

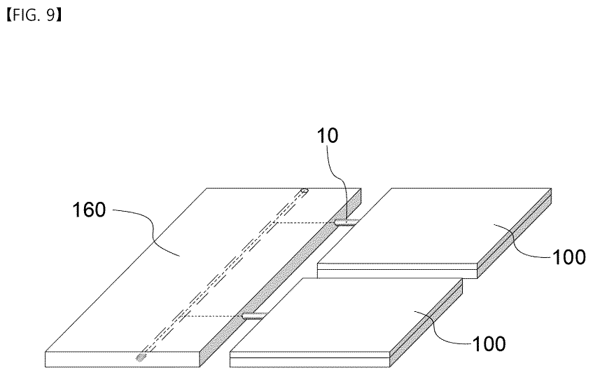

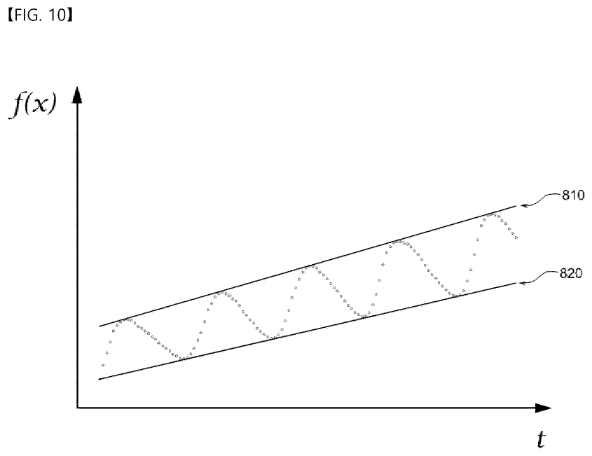

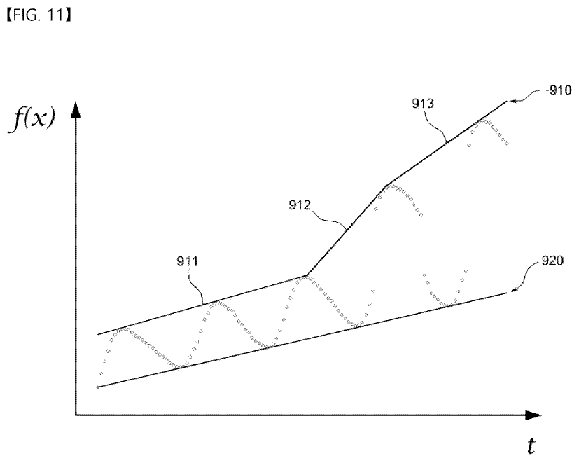

FIG. 1 is a configuration diagram of an electric heating tile (also referred to as “a smart tile”) according to one embodiment of the present disclosure, FIG. 2 is a diagram for describing a first layer of the electric heating tile according to one embodiment of the present disclosure, FIG. 3 is a diagram for describing a second layer of the electric heating tile according to one embodiment of the present disclosure, FIG. 4 is a diagram for describing the combination of the first layer and the second layer of the electric heating tile according to one embodiment of the present disclosure, FIGS. 5 to 7 are drawings to describe a top cover and a bottom cover of the electric heating tile according to one embodiment of the present disclosure, FIG. 8 is a diagram for describing a control module of the electric heating tile according to one embodiment of the present disclosure, FIG. 9 is a drawing to describe a side surface cover of the electric heating tile according to one embodiment of the present disclosure, and FIGS. 10 and 11 are diagrams for describing a fault diagnosis unit provided in the control module of the electric heating tile according to one embodiment of the present disclosure.

### First Embodiment

Referring to FIGS. 1 to 4, an electric heating tile 100 according to one embodiment of the present disclosure may include on a first layer 110 on which a copper pipe 111 is provided, a second layer 120 which is provided on the first layer 110 and patterned with at least one copper film 121, a top cover 130 covering an upper surface of the second layer 120, and a bottom cover 140 covering a lower surface of the first layer 110. In another embodiment, the second layer 120 may be patterned with at least one copper sheet instead of the at least one copper film 121.

For example, the top cover 130 may be made of various materials such as ceramic, wood, and synthetic resin, and the bottom cover may be made of a synthetic resin material such as PVC.

For example, an air gap is provided between the first layer 110 and the top cover 130 may be less than a preset maximum thickness (for example, 10 mm).

As another example, the pattern of the copper film 121 may be determined to correspond to the size and shape of the top cover 130. In one embodiment, the electric heating tile 100 may further include a thermal conductive material (e.g., a paste, a compound, or a flexible sheet) added to the bottom of the top cover 130. The thermal conductive material may be sandwiched between the second layer 120 or the copper film 121 and the top cover 130.

The thermal conductive material can efficiently transfer the heat from the second layer 120 or the copper film 121 to the top cover 130. The heat transfer efficiency is increased by the thermal conductiver material especially when the bottom of the top cover 130 has an uneven or a rough surface.

Meanwhile, referring to FIG. 5, the top cover 130 and the bottom cover 140 may be provided with at least one magnetic member 131 and 141 on one side surface.

Therefore, the electric heating tile 100 can be modularly combined by the magnetic members 131 and 141, the electric heating tile 100 can be constructed for the entire region, and the electric heating tile 100 may be partially placed in a region requiring a construction.

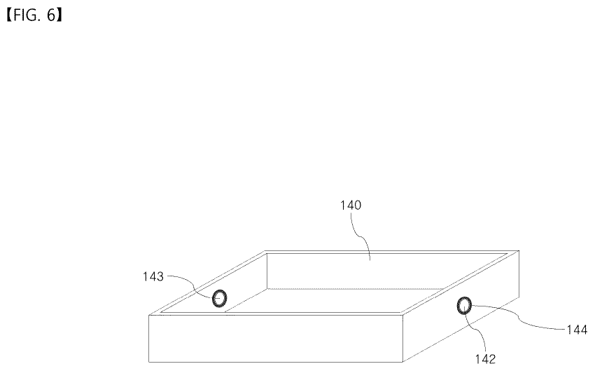

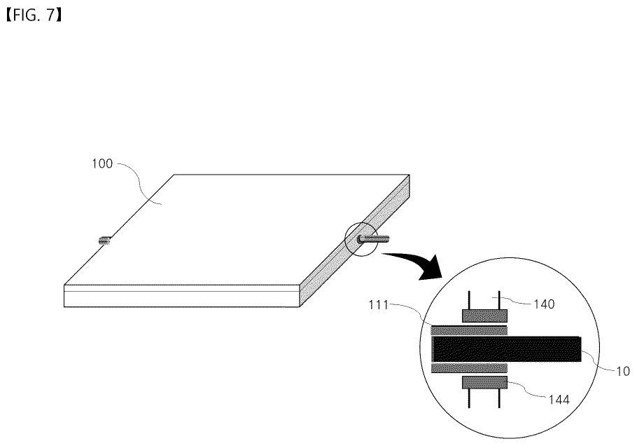

Meanwhile, referring to FIGS. 6 and 7, the bottom cover 140 may include a first inlet 142 provided on one side surface, a second inlet 143 provided on the other side surface facing the first inlet 142, and an insertion member 144 inserted into the first inlet 142 and the second inlet 143.

At this time, the insertion member 144 is made of an elastic material and is provided in a tubular shape with a through hole penetrating the inside, and the copper pipe 111 can be inserted into the through hole.

Preferably, the insertion member 144 may be made of silicon material.

Therefore, both ends of the copper pipe 111 provided in the first layer 110 can be protected by the insertion member 144, and movement of the copper pipe 111 can be minimized. In this embodiment, a long heating cable 10 runs through two or more electric heating tiles 100. In another embodiment, each electric heating tile 100 may include an embedded heating wire installed therein, as a section of the heating cable 10.

In this case, a heating cable 10 may be inserted into the copper pipe 111, and the heat generated by the heating cable 10 may be released to the top cover 130 through the copper pipe 111 of the first layer 110 and the copper film 121 of the second layer 120.

Meanwhile, as illustrated in FIG. 8, the electric heating tile 100 may further include a control module 150 that controls the heating state of the copper pipe 111.

More specifically, the control module 150 may include a temperature sensor 151 that measures the temperature of the top cover 130, a power supply unit 152 configured to supply power to the heating cable 10 inserted into the copper pipe 111, a communication unit 153 configured to receive a user control signal from a predetermined user terminal, and a temperature control unit 154 configured to control a heating temperature of the copper pipe 111 based on the user control signal received from the communication unit 153.

For example, the user control signal may include a heating reservation time, a maximum heating temperature, a minimum heating temperature, or the like.

Therefore, the temperature control unit 154 controls the heating state of the heating cable 10 by adjusting the magnitude and duty rate of the voltage applied to the heating cable 10 based on the user control signal.

Meanwhile, the copper pipe 111 of the first layer 110 is made of the same material as the copper film 121 of the second layer 120, and the copper pipe 111 and the copper film 121 may be joined by soldering.

Additionally, in the bottom cover 140, a region where the first layer 110 is mounted may be coated with an epoxy resin.

More specifically, an epoxy resin, or the like may be applied to an inner surface of the bottom cover 140 at a preset thickness (for example, 10 mm), and heat generated from the lower surface of the bottom cover 140 can be blocked by the epoxy resin.

That is, by applying an epoxy resin, or the like to the inner surface of the bottom cover 140, the temperature of the copper pipe 111 and the copper film 121 can be prevented from being affected by the heat rising from the bottom of the bottom cover 140, and the heat generated from the heating cable 10 inserted inside the copper pipe 111 can be released through the top cover 130.

Additionally, when the heating temperature of the copper pipe is input through the control module 150, heat loss due to cold floor air, or the like can be minimized.

Meanwhile, as illustrated in FIG. 9, the electric heating tile may further include a side surface cover 160 having the same thickness as a combined thickness of the bottom cover 140 and the top cover 130, including an empty space formed therein, and having at least one through hole on one side surface. The side surface cover 160 may further include cable or wire guides such as walls, pipes, cavities, or latches to guide or fix the heating cable 10 or electric wires that are routed in the inner space of the side surface cover 160.

The heating cable 10 penetrating the first inlet 142 and the second inlet 143 of the bottom cover 140 may be inserted through the through hole provided in the side surface cover 160. The heating cable 10 or electric wire may be connected between a first electric heating tile 100 and a second electric heating tile 100 through the side surface cover 160. The side surface cover 160 can be connected to another side surface cover 160 through the through hole containing the electric wire.

In other words, the tile construction can be completed by arranging the side surface cover (160) along the outer edge of the area where heat is supplied by the electric heating tile 100.

At this time, the side surface cover 160 may include at least one cutting line in horizontal and vertical directions, and the side surface cover 160 may be cut according to the shape of the floor.

For example, the side surface cover 160 may be made of plastic.

As another example, a thermally conductive sheet is attached to the side surface of the top cover 130 to induce rapid heat conduction between the electric heating tiles 100 when multiple electric heating tiles 100 are combined.

### Second to Fifth Embodiments

Meanwhile, the control module 150 may further include a fault diagnosis unit (not illustrated) that analyzes temperature data (sensor output data) collected through the temperature sensor 151.

The failure diagnosis unit (not illustrated) may analyze the sensor output data in real time and determine that a failure has occurred in the temperature sensor 151 when an instantaneous change rate of the sensor output data is equal to or greater than a preset value.

For this purpose, in the first embodiment, the instantaneous rate of change Rchange of the sensor output data is calculated, and when the instantaneous rate of change Rchange is greater than the preset limit value Serr, it can be determined that an error has occurred in the real-time output data of the sensor (for example, due to a failure of the sensor itself).

The instantaneous rate of change Rchange of the sensor output data can be calculated through a differential value ƒ′(x) of a function ƒ(x) that represents the characteristics of the sensor as illustrated in [Mathematical Expression 1] below.

$${R}_{change} = {f}^{′} ( x ) = {lim}_{Δ t - 0} ( \frac{f ( x + Δ t ) - f ( x )}{Δ t} ) \qquad [ Mathematical Expression 1 ]$$

Here, Rchange refers to the instantaneous change rate of the sensor output data, and Δt refers to the time change.

In the second embodiment, it can be determined that the sensor failure occurs only a case where the instantaneous rate of the sensor calculated in [Mathematical Expression 1] is greater than the preset limit value Serr is equal to or more than a preset number of times during the preset period. In other words, since it is difficult to determine a sensor failure in a one-off case with a high instantaneous rate, in order to improve the accuracy of sensor failure determination, the standard can be set to determine that a sensor failure occurs only when the number of failures exceeds a preset number of times during a preset period.

In the third embodiment, it can be determined that the sensor failure occurs only when the accumulated number of times the instantaneous change rate of the sensor calculated in [Mathematical Expression 1] is greater than the preset limit value Serr is greater than the preset number. Similar to the second embodiment above, since it is difficult to determine the sensor failure in a one-off case with a high instantaneous rate, in order to improve the accuracy of sensor failure determination, the standard can be set to determine that a sensor failure occurs only when the number of failures exceeds a preset number of times during a preset period.

In a fourth embodiment, when the instantaneous change rate of the sensor calculated in [Mathematical Expression 1] changes rapidly, it can be determined that the sensor has failed.

To this end, ƒ′(x) calculated in [Mathematical Expression 1] is differentiated again to calculate ƒ″(x), and when the calculated value is greater than a preset value, it can be determined that a failure has occurred in the sensor.

Meanwhile, in a fifth embodiment, even when it is determined that a failure has occurred in the sensor through any one of the first to fourth embodiments, the sensor failure is not immediately confirmed, and the sensor failure may be confirmed when the “unexpected data generation conditions” described below are simultaneously satisfied.

Here, in the unexpected data generation conditions, slopes of upper limit straight lines 810 and 910 connecting the upper limit values of the sensor output data and lower limit straight lines 820 and 920 connecting the lower limit values of the sensor output data are calculated as illustrated in FIGS. 10 and 11, and when the slope difference calculated in [Mathematical Expression 2] above is equal to or greater than a preset value, it can be determined that unexpected data has occurred.

Therefore, when it is determined that a failure has occurred in the sensor through any one of the first to fourth embodiments and the slope difference Idiff calculated in [Mathematical Expression 2] is equal to or greater than a preset value to satisfy the unexpected data generation condition, it can be set to confirm sensor failure.

$${I}_{diff} = \vert {I}_{max} - {I}_{min} \vert \qquad [ Mathematical Expression 2 ]$$

Here, Iₘₐₓ means the slope of the upper limit straight line connecting the upper limits of the sensor output data, Iₘᵢₙ means the slope of the lower limit straight line connecting the lower limits of the sensor output data, and I_{diff} means the slope difference (absolute value).

More specifically, as illustrated in FIGS. 10 and 11, the sensor data is collected at regular intervals, and the slopes of the upper limit straight line 810 connecting the upper end of the collected data and the lower limit straight line 820 connecting the lower end are calculated, respectively. Thereafter, the slope difference I_{diff} of the two straight lines is calculated, and when the difference is not large (less than the preset value), the sensor data is considered to be moving within the error range and it is determined that the sensor is operated normally. Moreover, when the slope difference Idiff between the two straight lines becomes larger than the preset value, it can be determined that the sensor has failed, as inaccurate values are being output due to the sensor failure.

That is, in the case of FIG. 10, the slope of the upper limit straight line 810 is 0.26 and the slope of the lower limit straight line 820 is 0.24, and thus, the slope difference Idiff between the two straight lines is 0.02, which is smaller than the preset reference value of 0.12, and it can be determined that the sensor is operated normally.

Meanwhile, when the upper limit straight line or lower limit straight line appears as a bent line, the slope may be compared by dividing the region for each section where the straight line is bent, or the slope may be compared by calculating the average slope within a certain period.

Referring to FIG. 11, first, a case where the slope is compared by dividing the region at each section where the straight line bends will be described. In FIG. 11, the upper limit straight line 910 includes three straight lines, and in the three straight lines, a first straight line 911 has a slope of 0.26, a second straight line 912 has a slope of 0.45, and a third straight line 913 has a slope of 0.26. is 0.38. When the lower limit straight line 920 has a slope of 0.24, in the case of the first straight line 911, the slope difference (0.26-0.24) with the lower limit straight line 920 is 0.02, which is less than the preset reference value of 0.12, and thus, it is determined that sensor is operated normally. However, in the case of the second straight line 912, the slope difference (0.45-0.24) with the lower limit straight line 920 is 0.21, which is greater than the preset reference value of 0.12, and thus, it is determined that the sensor is operated abnormally, and in the case of the third straight line 913, since the slope difference (0.38-0.24) with the lower limit straight line 920 is 0.14, which is larger than the preset reference value of 0.12, and thus, it is determined that the sensor is operated abnormally. In this way, when dividing the region at each section where a straight line bends, comparing the slope, and determining whether or not the failure occurs, the time when the failure occurs can also be estimated, which can be very useful when it is necessary to check when the failure occurs.

Next, the slopes can be compared by calculating the slope average within a certain period. The slope average of the upper limit straight line 910 in the entire section of FIG. 11 is {(0.24+0.45+0.38)/3}=0.35, and the difference with the slope average (0.24) of the lower limit straight line 920 is 0.11, which is less than the preset reference value of 0.12, and thus, it can be determined that the sensor is operated normally. In this way, determining failure by calculating the average slope within a certain period can lower the sensitivity of failure determination because even when there is a temporary slope change, as long as the average value does not exceed the reference value, it is not determined as failure. Therefore, unnecessary failure determination can be prevented.

### Sixth Embodiment

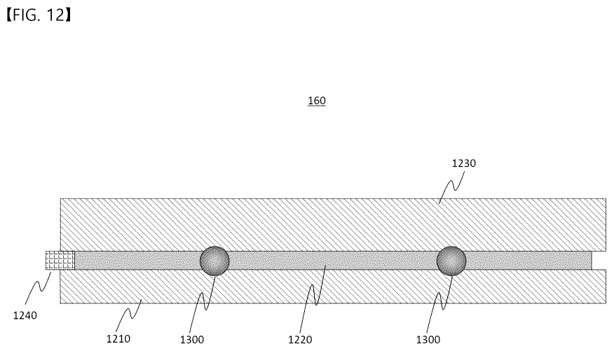

FIG. 12 is a configuration diagram of a side surface cover 160 according to one embodiment of the present disclosure. The side surface cover 160 in FIG. 12 is a modified example of the side surface cover 160 illustrated in FIG. 9, so description thereof is omitted below except for the differences therewith.

The side surface cover 160 may have a structure similar to the electric heating tile 100 illustrated in FIGS. 1 to 7. However, the side surface cover 160 may not include the second layer 120 with the at least one copper film 121. The side surface cover 160 may or may not include the first layer 110 on which the copper pipe 111 is provided. Instead, the side surface cover 160 may include an inner space or a space formed therein. Descriptions of structures of the side surface cover 160 in common with the electric heating tiles 100 illustrated in FIGS. 1 to 7 are omitted below.

In this embodiment, the side surface cover 160 may include a bottom cover 1210, a pipe 1220, a top cover 1230, a connector 1240, and one or more inlets 1300. The bottom cover 1210 is attached or adhered to the floor or the interior wall. The bottom cover 1210 may be made of a synthetic resin material such as PVC. In one embodiment, the bottom cover 1210 may include side surfaces or side walls facing the side surfaces or side walls of the adjacent electric heating tiles 100 or the adjacent side surface covers 160.

The pipe 1220 is provided on the bottom cover 1210. The pipe 1220 may be made of a synthetic resin material such as PVC. Instead, the pipe 1220 may be made of metal such as copper, iron, aluminum, or the like. The pipe 1220 provides an inner space or an empty space for routing the heating cable 10 or an electric wire therein. In another embodiment, instead of including the pipe 1220 to provide the inner space, the side surface cover 160 may include one or more spacers between the bottom cover 1210 and the top cover 1230 to provide the inner space.

The top cover 1230 covers the upper surface of the bottom cover 1210 and the pipe 1220. The top cover may be made of various materials such as ceramic, wood, or synthetic resin. The top cover 1230 may be placed or fixed on the side surfaces or the side walls of the bottom cover 1210.

One or more connectors 1240 are provided to connect the side surface cover 160 to one or more adjacent side surface covers 160. The connector 1240 may be inserted to a through hole on the side surface of the adjacent side surface cover 160. In another embodiment, the side surface cover 160 may include an inlet instead of the connector 1240.

One or more through holes 1300 are located on the side of the side surface cover 160 facing the sides of the one or more electric heating tiles 100. The inner spaces of the one or more through holes 130 are connected to the inner space of the pipe 1220. In another embodiment, the side surface cover 160 may not include a side surface or wall on at least one side, and may include openings instead of through holes 1300.

### Seventh Embodiment

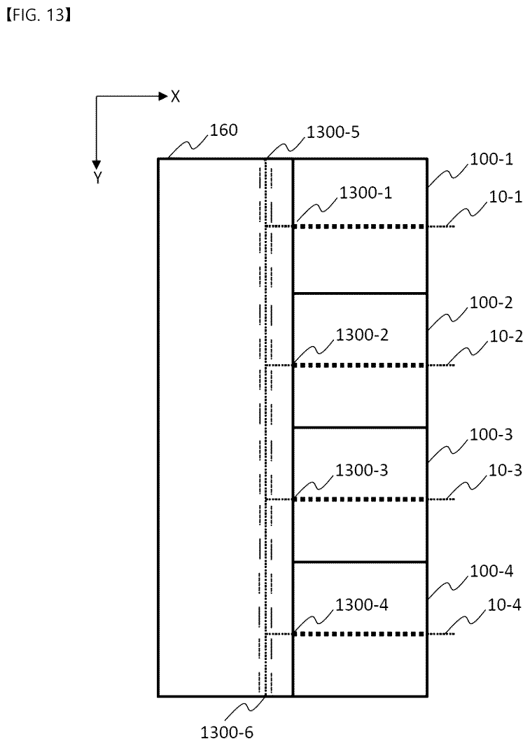

FIG. 13 is a diagram for describing a side surface cover 160 arranged along a side of electric heating tiles 100-1 to 100-4 (also referred to as the electric heating tile(s) 100) according to one embodiment of the present disclosure. FIG. 13 is a top view of the area where the side surface cover 160 and the electric heating tiles 100 are placed. The side surface cover 160 and the electric heating tiles 100 in this embodiment can also be applied to other embodiments.

A set of electric heating tiles 100-1 to 100-4 may further include a side surface cover 160. At least one side surface cover arranged 160 along a side of at least one of the plurality of electric heating tiles 100. The electric heating tiles 100-1 to 100-4 and the side surface cover 160 in FIG. 13 can be a portion of a heating apparatus.

As illustrated in FIG. 13, one or more electric heating tiles 100 may be arranged along at least one side of the side surface cover 160. In FIG. 13, four electric heating tiles 100-1 to 100-4 are arranged along a first direction (e.g., the Y direction) and the side surface cover 160 is arranged next to the electric heating tiles 100-1 to 100-4 in a second direction (e.g., the −X direction) perpendicular to the first direction. In case the electric heating tiles 100-1 to 100-4 are attached on a wall, the first direction (e.g., the Y direction) can be vertical, horizontal, or in any other direction.

The length of the edge of the side surface cover 160 along the plurality of the electric heating tiles 100 may be an integer multiple of the length of the corresponding edge of one electric heating tile 100. In FIG. 13, the length of the side surface cover 160 in the Y direction is four times that of one electric heating tile 100 in the Y direction. The length of the side surface cover 160 in the X direction (or width of the side surface cover 160) may be equal to the length of, more than or less than the length of, or an integer multiple of, the length of one electric heating tile 100 in the Y direction.

As explained in the first embodiment, the side surface cover 160 may be cut in horizontal or vertical directions. If the side surface cover 160 is cut, the length of the side surface cover 160 in the X direction may be less than the length of one electric heating tile 100 in the X direction.

The side surface cover 160 may include a first side facing a side of the first electric heating tile 100-1 and a side of the second electric heating tile 100-2. In FIG. 13, the +X side (i.e., the right side in FIG. 13) of the side surface cover 160 faces the −X side (i.e., the left side in FIG. 13) of two or more electric heating tiles 100.

The first side (i.e., +X side) of the first side surface cover may include two or more holes each of which is for inserting a wire between the first side surface cover 160 and the corresponding electric heating tile 100. In FIG. 13, The side surface cover 160 includes one or more through holes 1300-1 to 1300-4 (also referred to as the through hole(s) 1300) on the side (or the side surface) facing the sides (or the side surfaces) of the one or more electric heating tiles 100-1 to 100-4.

Each through hole 1300 faces the inlet of each electric heating tile 100. The heating cable 10 (or any kind of electric wire) penetrating the inlet of each electric heating tile 100 may be inserted to the corresponding through hole 1300. Here, the heating cable 10 may be a resistive wire that produces heat when an electric current flows through it. The heating cable 10 may be a resistive wire covered by an insulating heat-resistant cover.

The heating cable 10 (or any kind of electric wire) may be connected between two or more electric heating tiles 100 through the side surface cover 160 by using two or more through holes 1300. In the example of FIG. 13, the side surface cover 160 includes an inner space for passing a wire electrically connecting a first electric heating tile 100-1 and a second electric heating tile 100-2 of the plurality of electric heating tiles 100.

For example, the electric heating tiles 100-1 and 100-2 can be connected by the heating cable 10 including portions of heating cable 10-1 and 10-2 through the side surface cover 160. The electric heating tiles 100-3 and 100-4 can connected by the heating cable 10 including portions of heating cable 10-3 and 10-4 through the side surface cover 160.

The side surface cover 160 may include a second side (e.g., the +Y side or the −Y side) facing a side of another side surface cover 160. The second side of the side surface cover 160 may include a hole (e.g., a through hole 1300-5 or 1300-6) for inserting the heating cable 10 or a wire between the side surface cover 160 and another side surface cover 160. In FIG. 13, the side surface cover 160 includes holes 1300-5 and 1300-6 on the opposing sides (e.g., the +Y and −Y sides) that are orthogonal to the side facing the electric heating tiles 100.

The side surface cover 160 may further include cable or wire guides such as walls, pipes, cavities, or latches to guide or fix the heating cable 10 or electric wires that are routed in the inner space of the side surface cover 160.

### Eighth Embodiment

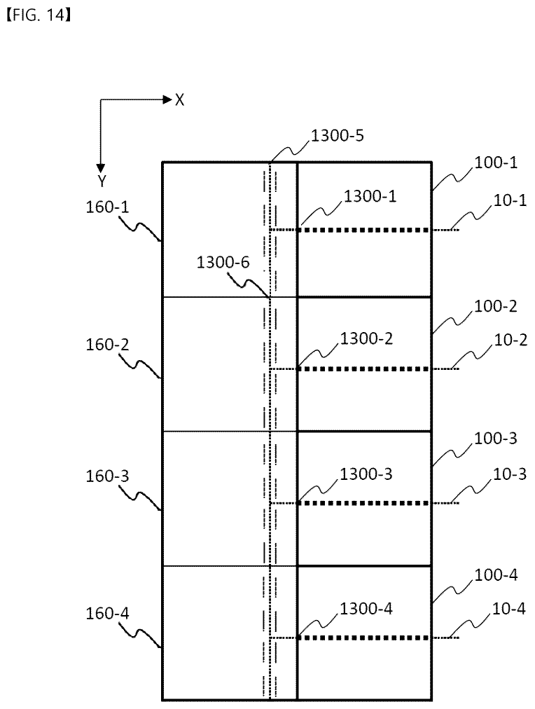

FIG. 14 is a diagram for describing side surface covers 160-1 to 160-4 (also referred to as the side surface cover(s) 160) arranged along a side of electric heating tiles 100-1 to 100-4 according to one embodiment of the present disclosure. The embodiment illustrated in FIG. 14 is an alternative of the embodiment illustrated in FIG. 13. Therefore, the differences of the embodiment of FIG. 14 from the embodiment of FIG. 13 are described, and descriptions of common structures are omitted.

A set of electric heating tiles 100-1 to 100-4 may further include side surface covers 160-1 to 160-4. The electric heating tiles 100-1 to 100-4 and the side surface covers 160-1 to 160-4 in FIG. 14 can be a portion of a heating apparatus. As illustrated in FIG. 14, a side surface cover 160 can be arranged next to another side surface cover 160. Here, the structure of the side surface cover 160-1 will be described as a representative of the plurality of side surface covers 160-1 to 160-4.

The length of the edge of the side surface cover 160-1 along the electric heating tiles 100 may be the same length as the corresponding edge of one electric heating tile 100-1. In FIG. 14, the length of the side surface cover 160-1 in the Y direction is the same length as one electric heating tile 100-1 in the Y direction.

The side surface cover 160-1 may include a first side (i.e., +X side) facing a side of the first electric heating tile 100-1. The first side of the side surface cover 160-1 may include at least one hole each of which is for inserting a wire between the first side surface cover 160-1 and the corresponding electric heating tile 100-1.

The side surface cover 160-1 may include a second side (e.g., the +Y side or the −Y side) facing a side of another side surface cover 160 such as the side surface cover 160-2. The second side of the side surface cover 160-2 may include one or more holes (e.g., a through hole 1300-5 or 1300-6) for inserting the heating cable 10 or a wire between the side surface cover 160 and another (adjacent) side surface cover 160. In FIG. 14, the side surface cover 160-1 includes holes 1300-5 and 1300-6 on the opposing sides (e.g., the +Y and −Y sides) that are orthogonal to the side facing the electric heating tile 100-1.

The heating cable 10 (or electric wire) may be connected between two or more electric heating tiles 100 through two or more side surface covers 160. In the example of FIG. 14, the electric heating tiles 100-1 and 100-2 can be connected by the heating cable 10-1 and 10-2 through the side surface covers 160-1 and 160-2, and the electric heating tiles 100-3 and 100-4 are connected by the heating cable 10-3 and 10-4 through the side surface covers 160-3 and 160-4.

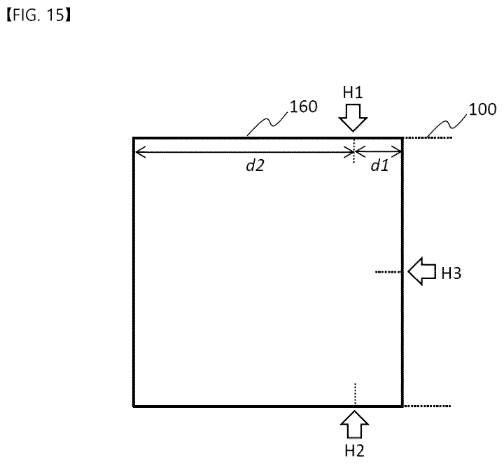

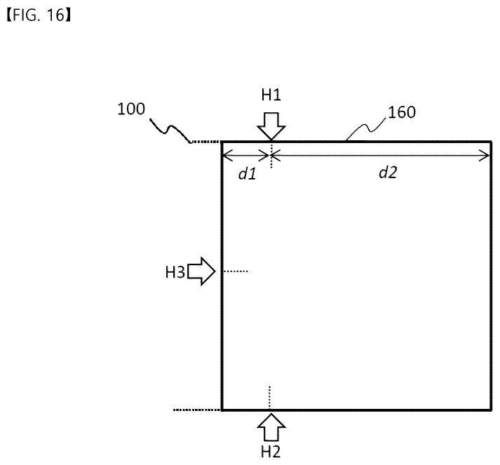

FIG. 15 and FIG. 16 are diagrams for describing positions of through holes in a side surface cover 160 according to one embodiment of the present disclosure. FIGS. 15 and 16 are the top views of the side surface cover 160. The side surface cover 160 in FIG. 15 is placed on the left of the electric heating tiles 100, and the side surface cover 160 in FIG. 16 is placed on the right of the electric heating tiles 100.

The side surface cover 160 may include at least one through hole (or openings) on two or more side surfaces. In the examples of FIGS. 15 and 16, the side surface cover 160 includes a through hole H1 on the side (i.e., the top edge of the side surface cover 160 in FIGS. 15 and 16), a through hole H2 on the side at the opposite s of the side including the through hole H1 (i.e., the bottom edge of the side surface cover 160 in FIGS. 15 and 16), and a through hole H3 on the side between the sides including the through holes H1 and H2. In FIG. 15, the through hole H3 is on the right side of the side surface cover 160 because the adjacent electric heating tile 100 is on the right of the side surface cover 160. In FIG. 16, the through hole H3 is on the left side of the side surface cover 160 because the adjacent electric heating tile 100 is on the left of the side surface cover 160. In the examples of FIGS. 15 and 16, the heating cable 10 (or electric wire) can be inserted through through holes H1 and H3, through through holes H2 and H3, or though through holes H1 and H2.

The through hole on the side facing the side of the adjacent side surface cover 160 (e.g., the through hole H1 or H2) may be formed closer to the side facing the electric heating tile 100 than the side opposite to the side facing the electric heating tile 100. In the example of FIGS. 15 and 16, the through hole H1 is formed closer to the side facing the side of the adjacent side surface covers 160, and the through hole H2 is formed closer to the side facing the side of the electric heating tile 100.

The distance between the through hole H1 and the side including the through hole H3 (i.e., the distance d1) is smaller than the distance between the through hole H1 and the opposite side of the side including the through hole H3 (i.e., the distance d2). Other through holes, such as the through hole H2, may be similarly positioned. With this structure, the side surface cover 160 can be cut more widely. In another embodiment, the through holes H1 and H2 can also be located at the center of the side surfaces of the side surface cover 160.

### Ninth Embodiment

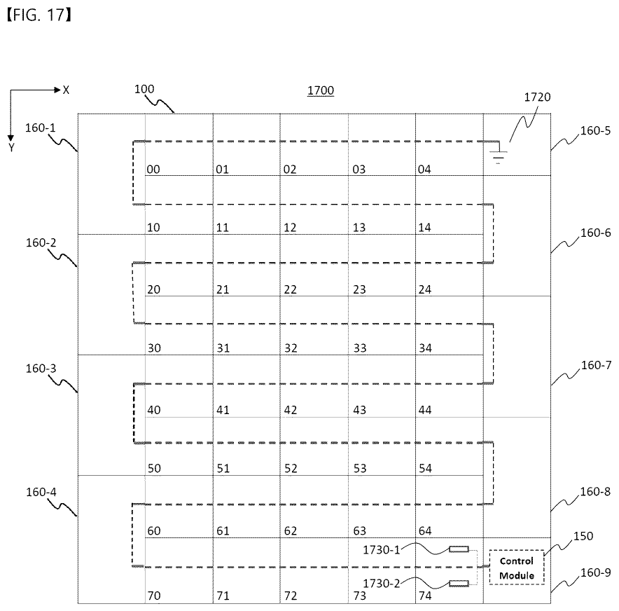

FIG. 17 is a diagram of a heating apparatus 1700 according to one embodiment of the present disclosure. The electric heating tiles 100 and the side surface covers 160 of other embodiments can be applied to the heating apparatus 1700 of this embodiment.

The heating apparatus 1700 includes a plurality of electric heating tiles 100, a plurality of side surface cover 160-1 to 160-9 (also referred to as the side surface cover(s) 160), a control module 150, and one or more sensors 1730-1 to 1730-2 (also referred to as the sensor(s) 1730).

The plurality of electric heating tiles 100 are arranged on a floor or an interior wall of a building. In this embodiment, the plurality of electric heating tiles 100 are arranged in a two-dimensional grid. In FIG. 17, each electric heating tile 100 is numbered based on its column position (the X position) and its row position (the Y position) as shown in the lower left of the rectangle representing each electric heating tile 100. An electric heating tile 100 at (X, Y)=(i, j) is numbered ji (row and column order), and also referred to as the electric heating tile 100-ji. For example, the electric heating tile 100 at row 3, column 2 is referred to as the electric heating tile 100-32.

The plurality of side surface covers 160 includes a first plurality of side surface covers 160-1 to 160-4 arranged along a first outer edge (e.g., the left edge in FIG. 17) of an area where the plurality of electric heating tiles 100 are arranged in the two-dimensional grid. The plurality of side surface cover 160 also includes a second plurality of side surface covers 160-5 to 160-9 arranged along a second outer edge (e.g., the right edge in FIG. 17) of an area where the plurality of electric heating tiles 100 are arranged in the two-dimensional grid. The plurality of electric heating tiles 100 and the plurality of side surface cover 160 may be connected magnetically, as explained by using FIG. 5. Alternatively, the plurality of electric heating tiles 100 and the plurality of side surface cover 160 may be connected by means of latches, screws, bolts, adhesive, or the like.

At least one side surface cover 160 (e.g., the side surface cover 160-9 in FIG. 17) may include an inner space for containing equipment such as control module 150, the power supply unit 152, or the like. In FIG. 17, the side surface cover 160-9 contains the control module 150.

The control module 150 in FIG. 17 may be the control module 150 illustrated in FIG. 8 or another control module. The control module 150 is connected to the heating cable 10 and configured to control the heating temperature of the heating apparatus 1700 based on the user control signal received from the communication unit 153 in the control module 150.

In this embodiment, the heating cable 10 or a wire running through a first row of electric heating tiles 100 in the area and a wire running through a second row of the electric heating tiles 100 in the area are connected through at least one side surface cover of the first plurality of side surface covers 160. The second row may be adjacent to the first row.

As illustrated in FIG. 17, the plurality of electric heating tiles 100 are electrically connected in series between the control module 150 and the ground 1720. In more detail, the heating cable 10 from the control module 150 passes through a first row (row 7 in FIG. 17) of electric heating tiles 100-74 to 100-70 in the −X direction. The side surface cover 160-4 folds back the heating cable 10 from the electric heating tile 100-70 and routes the heating cable 10 to a second row (row 6 in FIG. 17) of electric heating tiles 100-60 to 100-64. The second row may be adjacent to the first row in FIG. 17. Alternatively, the second row can be apart from the first row.

The heating cable 10 from the side surface cover 160-4 passes through the second row of electric heating tiles 100-60 to 100-64 in the +X direction. In similar manner, the heating cable passes through each row of the electric heating tiles 100, and reaches to the ground 1720 in the side surface cover 160-5. The ground 1720 may be connected to the control module 150 by an electric wire through the side surface covers 160-5 to 160-9.

In this embodiment, a long heating cable 10 is inserted to each of the electric heating tile 100 and each of the side surface cover 160 so that one long heating cable 10 from the side surface cover 160-9 reaches to the side surface cover 160-5 where the ground 1720 is located.

Instead of this, each electric heating tile 100 and/or each side surface cover 160 may include a section of the heating cable 10 installed or embedded therein, and each section of the heating cable 10 may be connected to the adjacent sections of the heating cable 10 in an adjacent electric heating tile 100 (or an adjacent side surface cover 160) through an electric connector by attaching or placing the adjacent electric heating tile 100 (or the adjacent side surface cover 160) at the side of the electric heating tile 100 (or the adjacent side surface cover 160).

In this embodiment, the two-dimensional area on a floor or a wall can be heated by one long heating cable 10. Alternatively, the heating cable 10 may include non-heating or non-resistive sections that are placed in the side surface covers 160.

One or more sensors 1730 are connected to the control module 150. The sensor 1730 may be the temperature sensor 151 in FIG. 8, anomaly detection sensor, or other sensor. Anomaly detection sensor may detect wire break or disconnection of the heating cable 10. Alternatively, the control module 150 may detect wire break or disconnection of the heating cable 10 by checking the current flowing through the heating cable 10.

### Tenth Embodiment

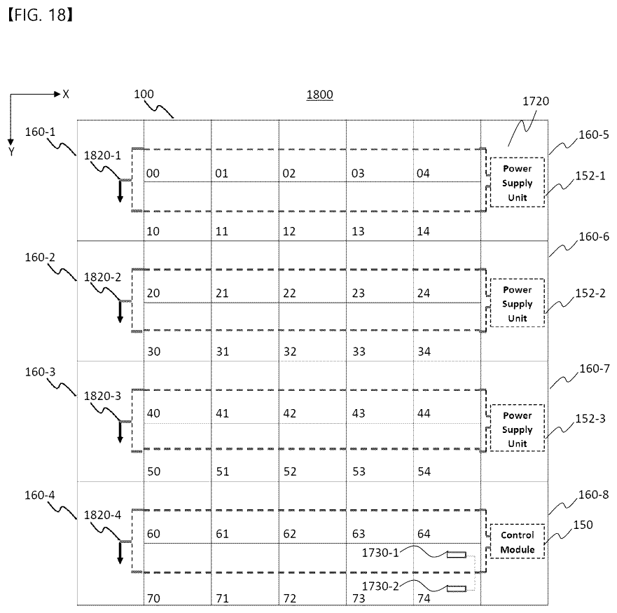

FIG. 18 is a diagram of an heating apparatus 1800 according to one embodiment of the present disclosure. The electric heating tiles 100 and the side surface covers 160 of other embodiments can be applied to the heating apparatus 1800 of this embodiment. The embodiment illustrated in FIG. 18 is an alternative of the embodiment illustrated in FIG. 17. Therefore, the differences of the embodiment of FIG. 18 from the embodiment of FIG. 17 is described and descriptions of common structures are omitted.

The heating apparatus 1800 includes a plurality of electric heating tiles 100, a plurality of side surface cover 160-1 to 160-8 (also referred to as the side surface cover(s) 160), a control module 150, one or more power supply units 152-1 to 152-3 (also referred to as the power supply unit(s) 152), and one or more sensors 1730-1 to 1730-2 (also referred to as the sensor(s) 1730).

The plurality of electric heating tiles 100 are arranged on a floor or an interior wall of a building. In this embodiment, the plurality of electric heating tiles 100 are arranged in a two-dimensional grid.

The plurality of side surface 160 cover includes a first plurality of side surface covers 160-1 to 160-4 arranged along a first outer edge (e.g., the left edge in FIG. 18) of an area where the plurality of electric heating tiles 100 are arranged in the two-dimensional grid. The plurality of side surface cover 160 also includes a second plurality of side surface covers 160-5 to 160-8 arranged along a second outer edge (e.g., the right edge in FIG. 18) of an area where the plurality of electric heating tiles 100 are arranged in the two-dimensional grid. The side surface covers 160-5 to 160-8 may include an inner space for containing equipments such as the control module 150 or the power supply unit 152-1 to 152-3.

The heating cable 10 or a wire running through at least one row of electric heating tiles 100 in the area is connected between the control module 150 (or the power supply unit 152) in a side surface cover 160 arranged along the first outer edge and a ground 1820 in a side surface cover 160 arranged along the second outer edge. For example, the heating cable 10 running through the row of electric heating tiles 100-04 to 100-00 is connected between the power supply unit 152-1 in the side surface cover 160-5 at the right edge of the area and the ground 1820-1 in the side surface cover 160-1 at the left edge of the area. The heating cable 10 running through the row of electric heating tiles 100-64 to 100-60 is connected between the control module 150 in the side surface cover 160-8 at the right edge of the area and the ground 1820-4 at the left edge of the area.

The power supply units 152-1 to 152-3 may be connected to the control module 150 by one or more control wires through the side surface covers 160-5 to 160-8. The power supply units 152-1 to 152-3 may be controlled by the control module 150 through the control wire(s). The grounds 1820-1 to 1820-4 may also be connected to the power supply unit 152-1 to 152-3 and the control module 150 respectively through rows of the electric heating tiles 100.

The control module 150 and the power supply units 152-1 to 152-3 are contained in the inner spaces of the side surface covers 160-5 to 160-8. Each of the control module 150 and the power supply units 152-1 to 152-3 supplies power to a wire that runs at least one row of electric heating tiles 100.

Alternatively, the control module 150 or the power supply unit 152 may provide the ground level to the heating cable 10. In this implementation, the heating cable 10 from the control module 150 or the power supply unit 152 goes through two rows of the electric heating tiles 100 and loops back to the control module 150 or the power supply unit 152. For example, the control module 150 provide a heating voltage to the heating cable 10 inserted in the electric heating tile 100-74 and provide a ground level to the heating cable 10 from the electric heating tile 100-64. In this implementation, the ground 1820-4 is not required in the side surface cover 160-4.

In this embodiment, the number of the power supply unit 152 can be increased as the size of the heating area is increased.

### Eleventh Embodiment

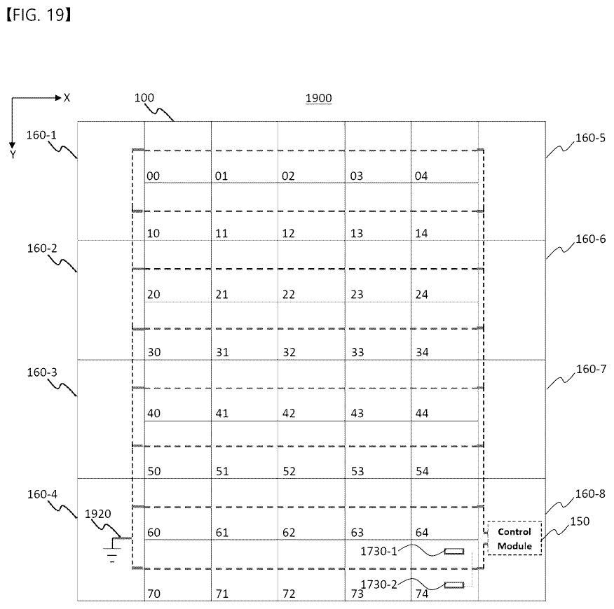

FIG. 19 is a diagram of an heating apparatus 1900 according to one embodiment of the present disclosure. The electric heating tiles 100 and the side surface covers 160 of other embodiments can be applied to the heating apparatus 1900 of this embodiment. The embodiment illustrated in FIG. 19 is an alternative of the embodiments illustrated in FIGS. 17 and 18. Therefore, the differences of the embodiment of FIG. 19 from the embodiments of FIGS. 17 and 18 are described and descriptions of common structures are omitted.

The heating apparatus 1900 includes a plurality of electric heating tiles 100, a plurality of side surface covers 160-1 to 160-8 (also referred to as the side surface cover(s) 160), a control module 150, and one or more sensors 1730-1 to 1730-2 (also referred to as the sensor(s) 1730).

The plurality of electric heating tiles 100 are arranged on a floor or an interior wall of a building. In this embodiment, the plurality of electric heating tiles 100 are arranged in a two-dimensional grid.

The plurality of side surface covers 160 includes a first plurality of side surface covers 160-1 to 160-4 arranged along a first outer edge (e.g., left edge in FIG. 19) of an area where the plurality of electric heating tiles 100 are arranged in the two-dimensional grid. The plurality of side surface covers 160 also includes a second plurality of side surface covers 160-5 to 160-8 arranged along a second outer edge (e.g., right edge in FIG. 19) of an area where the plurality of electric heating tiles 100 are arranged in the two-dimensional grid. The side surface cover 160-8 may include an inner space for containing the control module 150.

In this embodiment, two or more heating cables 10 or wires each of which runs through different row of electric heating tiles 100 are connected in parallel between a power supply unit 152 of the control module 150 in a side surface cover 160 arranged along the first outer edge and a ground 1920 in a side surface cover 160 arranged along the second outer edge. For example, the heating cables 10 running through the rows 0 to 7 respectively are connected in parallel between the control module 150 and the ground 1920. The control module 150 is connected to the heating cable 10 of each row through the side surface covers 160-5 to 160-8. The ground 1920 is connected to the heating cable 10 of each row through the side surface covers 160-1 to 160-4.

In this embodiment, the two-dimensional area on a floor or a wall can be heated by one (or fewer) control module 10. Further, the heating apparatus 1900 can keep working even if the heating cable 10 in some rows are broken or disconnected.

According to the present disclosure as above, the copper pipe made of copper into which the heating cable such as the electric heating wire is inserted and the copper film formed on the top of the copper pipe are provided inside the tile. Accordingly, it is possible to provide the electric heating tile in which the heat generated by the heating cable is more easily released through the upper surface of the tile.

Additionally, by providing at least one magnetic member on one side surface, it is possible to provide the electric heating tile that is easy to install and maintain through the coupling by the magnet.

In addition, by including the control module that is electrically connected to the electric heating tile, it is possible to provide the electric heating tile that can measure the temperature of the copper pipe and safely control the heating state of the electric heating tile.

Additionally, a method of controlling the electric heating tile according to one embodiment of the present disclosure may be recorded on a computer-readable medium including program instructions for performing various computer-implemented operations. The computer-readable medium may include program instructions, data files, data structures, or the like, singly or in combination. The medium may be one in which program instructions are specifically designed and configured for the present disclosure, or may be known and available to those skilled in the art of computer software. Examples of computer-readable recording media include magnetic media such as hard disks, floppy disks, and magnetic tapes, optical media such as CD-ROMs and DVDs, magneto-optical media such as floptical disks, and hardware devices specifically configured to store and perform program instructions such as ROM, RAM, and flash memory. Examples of program instructions include machine language code, such as that produced by a compiler, as well as high-level language code that can be executed by a computer using an interpreter, or the like.

As described above, although one embodiment of the present disclosure has been described through limited examples and drawings, one embodiment of the present disclosure is not limited to the above-described embodiments, and various modifications and variations can be made from these descriptions by those skilled in the art in the field to which the present disclosure belongs. Therefore, one embodiment of the present disclosure should be understood only by the scope of claims described below, and all equivalent or equivalent modifications thereof will be said to fall within the scope of the present disclosure idea.

What is claimed is:

1. An heating apparatus comprising:
a plurality of electric heating tiles arranged on a floor or an interior wall of a building; and
at least one side surface cover arranged along a side of at least one of the plurality of electric heating tiles,
wherein a first side surface cover of the at least one side surface cover includes an inner space for passing a wire electrically connecting a first electric heating tile and a second electric heating tile of the plurality of electric heating tiles.

2. The heating apparatus of claim 1, wherein the first side surface cover includes a first side facing a side of the first electric heating tile and a side of the second electric heating tile, and
wherein the first side of the first side surface cover includes:
a hole or opening for inserting a wire between the first side surface cover and the first electric heating tile and
a hole or opening for inserting a wire between the first side surface cover and the second electric heating tile.

3. The heating apparatus of claim 2, wherein the first side surface cover includes a second side facing a side of a second side surface cover of the at least one side surface cover.

4. The heating apparatus of claim 3, wherein the second side of the first side surface cover includes a hole or opening for inserting a wire between the first side surface cover and the second side surface cover.

5. The heating apparatus of claim 1, wherein a second side surface cover of the at least one side surface cover includes an inner space for containing a power supply unit configured to supply power to a wire that runs through at least one electric heating tile of the plurality of electric heating tiles.

6. The heating apparatus of claim 1, wherein the plurality of electric heating tiles are arranged in a two-dimensional grid, and
wherein the at least one side surface cover includes:
a first plurality of side surface covers arranged along a first outer edge of an area where the plurality of electric heating tiles are arranged in the two-dimensional grid, and
a second plurality of side surface covers arranged along a second outer edge of the area, the second outer edge being opposite of the first outer edge with respect to the area.

7. The heating apparatus of claim 6, wherein a wire running through a first row of electric heating tiles in the area and a wire running through a second row of the electric heating tiles in the area are connected through at least one side surface cover of the first plurality of side surface covers, the second row being adjacent to the first row.

8. The heating apparatus of claim 6, wherein a wire running through at least one row of electric heating tiles in the area is connected between a power supply unit in a side surface cover arranged along the first outer edge and a ground in a side surface cover arranged along the second outer edge.

9. The heating apparatus of claim 6, wherein two or more wires each of which runs through different row of electric heating tiles are connected in parallel between a power supply unit in a side surface cover arranged along the first outer edge and a ground in a side surface cover arranged along the second outer edge.

10. The heating apparatus of claim 1, wherein adjacent electric heating tiles of the plurality of electric heating tiles is connected magnetically.
